(19) United States
(12) Patent Application Publication
(10) Pub. No.: US 2007/0034568 A1
(43) Pub. Date: Feb. 15, 2007

(54) Particle synthesis apparatus and method

(76) Inventors: Neil Russell Foster, New South Wales (AU); Fariba Dehghani, New South Wales (AU); Gary Combes, Stockton-on-Tees (GB); Hubert Leonardus Regtop, New South Wales (AU)

Correspondence Address: DLA PIPER US LLP, 4365 EXECUTIVE DRIVE, SUITE 1100, SAN DIEGO, CA, 92121-2133, US

(21) Appl. No.: 10/552,390

(22) PCT Filed: Apr. 8, 2004
(86) PCT No.: PCT/AU04/00466

§ 371 Date: May 30, 2006

(30) Foreign Application Priority Data
Apr. 8, 2003 (AU) 2003901645

(51) Int. Cl. B01D 11/00

(52) U.S. Cl. 210/634; 424/489; 264/5; 210/511

(57) ABSTRACT

An apparatus for dissolving or suspending a substance in a solvent comprising an outer chamber for containing a dense gas; an inlet for supplying dense gas as a solvent; a porous chamber within the outer chamber for containing a substance for dissolution or suspension with the solvent, the porous chamber having a wall which allows passage of solvent and the substance dissolved or suspended in the solvent, and an outlet for removing solvent and solution and/or dispersion from the outer chamber and a turbulence means for creating turbulence within the porous chamber. A method of dissolving or suspending a substance, and fine particles formed from the resulting solution or suspension are disclosed.

The present invention relates to an apparatus and method for enhancing mass transfer between two substances in different phases which are to be mixed, or one suspended or dissolved in the other. It has particular but not exclusive application to suspending or dissolving particles of a substance, such as a pharmaceutical or biological substance, in a solvent.

### BACKGROUND

Throughout this specification, unless stated otherwise, where a document, act or item of knowledge is referred to or discussed, this reference or discussion is not an admission that the document, act or item of knowledge, or any combination thereof, at the priority date, was part of the common general knowledge.

The invention has many applications but is described herein the context of using dense gases or supercritical fluids to manipulate a substance.

Throughout the description, the term “dense gas” means a fluid near or above its critical pressure (Pc) and temperature (Tc). In practice, the pressure of the fluid is likely to be in the range (0.5-1.5)Pc and its temperature (0.5-1.2)Tc. The terms “dense gas” and “expanded fluid” are used synonymously.

Dense gas techniques utilising fluids, near or above their critical point, as a solvent or anti-solvent have been developed in recent years. At least two dense gas methods have been considered for the production of solid particles, both of which include a step of dissolving the solid in a solvent. The first method is known as the Rapid Expansion of Supercritical Solutions (RESS), and involves expanding a supercritical solution of the material of interest through a nozzle. Whilst providing an effective method for producing particles in some circumstances, the applicability of the RESS method is limited by the low solubility of proteins and other pharmaceuticals in dense gasses. To overcome this, a high solvent: solute ratio is required, which increases costs in both purchasing and handling the high volumes of solvent required. Even so, processing times are long given the mass transfer limitations of the solubilisation process. It is these processing times which in effect, impose a limit on the viability of the RESS process for a given solute.

The second method, known as the gas anti-solvent (GAS) process, involves rapidly precipitating solutes from organic solutions, typically using an anti-solvent, such as dense carbon dioxide. The anti-solvent expands the solution, thereby decreasing the solvation power of the solvent, and eventually resulting in the precipitation of the solute. Gas anti-solvent processes have been utilised for the generation of micron-sized particles in two modes. The first mode, known simply as the gas anti-solvent process (GAS), involves the gradual addition of an anti-solvent to the organic solution containing the solute until the precipitation occurs. The second mode, known as the Aerosol Solvent Extraction System (ASES), involves continuous introduction of a solution containing the solute of interest through a nozzle into a flowing dense gas stream. As the solution is sprayed in to the dense gas, high degrees of supersaturation result in the precipitation of fine particles. However, again, these processes are inefficient as they provide limited contact between the solute and the dense gas, which limits the efficiency of the process.

One example of a known apparatus for the RESS process is set out in FIG. 1. As can be seen, solvent (such as CO₂) enters a pump B at A and flows through a valve C. The flowpath divides into two paths controlled by valves D and E. CO₂ proceeding to the equilibrium cell F via heating coil G enters the cell in which the solute has already been located. The solute dissolves in the equilibrium cell F. This step is usually rate-limiting for the whole process. Filter H prevents undissolved solute from passing further through the system. Equilibrium cell F is located within water bath J which is maintained at a constant temperature by heater K. The CO₂/solute “solution” then passes from filter H at a temperature and pressure monitored by the temperature indicator TI and pressure indicator Pi and through valve D to heated region L into an expansion chamber M where precipitation of the solute occurs. This may be assisted by direct solvent passing from valve C through heating coil N and valve E. Particles can be retrieved from expansion chamber M and some are trapped by filter P where they are carried by the exhaust of the solvent.

This invention is directed towards an apparatus which operates in a more efficient manner and enables greater and quicker solution/dissolution of solute in the solvent, which is often a rate-limiting step as outlined above.

### SUMMARY OF THE INVENTION

The invention therefore provides an apparatus for dissolving or suspending a substance in a solvent comprising:

an outer chamber for containing a dense gas;

an inlet for supplying dense gas as a solvent;

a porous chamber within the outer chamber for containing a substance for dissolution or suspension in the dense gas, the porous chamber having a wall which allows passage of dense gas and the substance dissolved or suspended therein; and

an outlet for removing solvent and solution and/or dispersion from the outer chamber and a turbulence means for creating turbulence within the porous chamber.

It has been found that this apparatus, used in place of equilibrium chamber F in FIG. 1 (and which does not require water bath J either) enables faster and better dissolution of solute in the dense gas (eg. CO₂).

In a preferred form of the invention, the outer chamber is a pressure vessel and the porous chamber is manufactured from a sintered material, preferably stainless steel. The porous chamber may be cylindrical in shape, with the base and sides being porous. The pores in the wall(s) and base of the porous chamber are preferably created by sintering. The pores may be about 0.5 to 5 microns diameter, preferably about 1 micron. The outer chamber may conveniently be a high pressure autoclave.

In one example, the porous chamber is cylindrical in shape, with a diameter of about 50 mm and height of 100 mm in an outer chamber of 1 litre capacity. The inlet in the outer chamber may deliver fluid directly to a mouth within the porous inner chamber. Alternatively, the mouth of the inlet is in the wall of the outer chamber, outside the porous chamber, supplying solvent to an annular region between the inner chamber and the outer chamber. In another embodiment, there are inlets in both these positions.

The outlet is desirably located outside the porous chamber. The outlet may be a tube or conduit having a mouth in the outer chamber, outside the porous chamber, and leading outside the outer chamber. The tube may lead to an expansion chamber for a RESS particle precipitation for example. Alternatively, the outlet may be directly connected to a nozzle for solution expansion.

The means for creating turbulence may include a stirrer located within the inner chamber and driving means to drive the stirrer, or rotation of the chamber itself.

The driving means may be a magnetic stirrer driver which is preferably capable of rotating the stirrer at speeds of 500 to 4000 rpm while the chamber is pressurised with dense gas. About 800 rpm is one useful speed of rotation.

In another form, the driving means is a magnetic driver which rotates the porous inner chamber about an axis. To effect sufficient turbulence within the chamber, the rotation speed of the inner chamber is preferably 200 rpm to 3000 rpm and more preferably 500-1500 rpm, and most preferably around 800 rpm.

To further increase turbulence, the outer chamber may further include baffles on its interior surface. These baffles extend from the interior surface of the outer chamber and may extend to be in the proximity of the inner chamber. The baffles increase turbulence within the outer chamber during operation and it is believed that this turbulence reduces the tendency of the solvent to move towards the walls of the outer chamber.

The substance may be in a solid phase and it may be in particulate form. Preferably, the resulting solution is used in a dense gas or supercritical fluid process. The porous chamber may be provided with a plug to hold the solute against the base of the chamber. The plug may be a planar element (of the same cross-sectional shape as the chamber) abutting the sides of the porous chamber held against the solute by a resilient biasing means, such as a spring.

In use, the solvent is fed continuously into the outer chamber, creating a higher pressure in the region between the wall of the outer chamber and inner chamber which urges the solvent into contact with the solute in the inner chamber.

The resulting solution then passes through or is drawn through the outlet. Hence the solute is transferred in solution from the porous chamber into the region where it is extracted from the outer chamber.

A preferred use of the invention is the formation of fine particles of the substance from a substance/dense gas solution. This applies to the GAS process, or its variations, and also the RESS process described above. This alleviates a significant problem in scaling-up and making these processes continuous. In the RESS process, the solution passing from the porous chamber through the pores into the outer chamber may be permitted to flow out of the outer chamber under its own pressure through a valve at the outlet at a controlled rate such that it expands, thus precipitating fine particles of the substance.

In another aspect of the invention, there is provided a method of dissolving or suspending a substance in a dense gas comprising the steps of:

adding the substance to a porous chamber located within an outer chamber;

supplying the outer chamber with a dense gas as a solvent;

contacting the substance with the solvent within the porous chamber to form a solution or suspension within the porous chamber;

passing the solution or suspension through the walls of the porous chamber and removing the solution or suspension from the outer chamber.

In one preferred use of the invention, the substance is located in the porous chamber and the outer chamber is then pressurised by dense gas being introduced into the region around the porous chamber, defined by the walls of the outer chamber. The flow rate of the dense gas can be adjusted to optimise particle dissolution. In some cases, it may be desirable to have a mixture of dense gases or a modified dense gas (ie, a mixture of dense gas and modifier). The stirrer or rotating porous chamber creates rapid movement of particles of the substance and fluids within the porous chamber. It also induces convection within the porous chamber and effectively increases the available surface area of the solute. In this turbulent environment, the solid phase substance dissolves in the dense gas, and then flows out as the dense gas/solute “solution” from the porous chamber through the sintered pores, and then through the outlet.

In another preferred form of the invention, the dense gas is introduced through an axial shaft directly into the porous chamber. Thus with the rotation of the porous chamber, there is a forced convection flow of dense gas, which may be CO₂, into the porous chamber and through the porous walls of the chamber. As the dense gas is delivered to the porous chamber under supercritical or near critical conditions, it contacts and forms a solution with the solute. The convective flow of the dense gas/solute “solution” though the porous chamber walls is then passed to the outlet of the outer chamber.

In a preferred form of the invention, the porous chamber is provided with a longitudinally extending shaft which defines an annular region in the porous chamber. The solute is positioned within the annular region and dense gas fed into the longitudinally extending shaft. The shaft is porous or perforated to allow contact of the dense gas and solute over the length of shaft in contact with solute. This arrangement further increases the available contact surface area for the dense gas to diffuse into solute bed. This arrangement has the benefit of providing forced convective flow of dense gas through the porous wall and increased passage of gas through the packed solute in the annular region.

Without being bound by any particular theory or mode of action, it is believed that the hydrodynamics within a chamber of known apparatus are a constraint on particle generation. In the apparatus of the invention, the rotating chamber or stirrer increases turbulence within the chamber which, in turn, decreases the size of the boundary layer between particles of the substance (solute) and the dense gas flowing around it, within which mass transfer is severely limited. This aids in increasing the efficiency of contact between solute and solvent. This therefore enables a significant increase in the limits of the maximum flow rate of the solute/dense gas solution in a process otherwise limited by the slowness with which the solute dissolves in the dense gas. Accordingly, in one use, particle precipitation processes are quicker and more efficient than known processes with use of the invention because dissolution of the substance (solute) is quicker.

Increased speed of production through reduced residence time is an important advantage achieved, as a result of the improved contact between the dense gas and solute. Further, the apparatus also provides better mass transfer. There is also a reduction in time required to achieve saturation of solute in the dense gas. The apparatus has the ability of being scaled up to a larger capacity, to run continuously and for longer run times to make it more attractive for industrial applicability.

One means of making the process at least semi-continuous is to run more than one apparatus in parallel operation so that multiple batches are being processed simultaneously.

The invention also provides a method for producing fine particles using apparatus according to the invention. The invention also provides fine particles produced according to the apparatus of the invention. Preferably the substance is a biologically active substance. More preferably, the substance is a pharmaceutical or biological active used for diagnostic or therapeutic purposes.

In another aspect, the dense gas comprises a modifying agent to modify the polarity of the dense gas. The method of the present invention is capable of producing fine particles of the substance, and is particularly useful for the production of fine particles of pH sensitive substances and biologically active substances, since the biological activity of such substances may be retained.

The modifying agent may be present in an amount sufficient to modify the dense gas as required for the end use of the dense gas process.

The dense gas can be at various temperatures and pressures. Preferably the temperature of the dense gas is in the range of −20° C. to about 100° C., most preferably about 5° C. to about 45° C. The lower temperatures result in increased viscosity and reduced mass transfer properties, and this reduces the efficiency of the method. High temperatures are more costly to run and may damage the substance. Preferably the dense gas has a pressure in the range of 0.2 Pc<P<10 Pc where Pc is the critical pressure of the dense gas system. A pressure between about 5 to 200 bar is particularly preferred.

The particles produced by the method of the invention may also include delivery agents such as liposomes, lipids (including phospholipids), water soluble polymers, controlled-delivery coatings, surfactants, phytosterols, and any other delivery agents known in the art.

Preferably, at least half, and more preferably substantially all, of the fine particles produced by the method of the invention have a particle size less than 10,000 nm. More preferably, the fine particles have a size no greater than 6,500 nm. Particles having a size in the range of up to 5,000 nm are particularly useful for administration to the lung. If smaller particles are desired, it is believed that the method of the present invention can produce particles down to nanometre size.

The active substance is preferably selected from the group consisting of an antimicrobial agent, virus, antiviral agent, antifungal pharmaceutical, antibiotic, nucleotide, DNA, antisense DNA, RNA, antisense RNA, amino acid, peptide, protein, enzyme, hormones, immune suppressant, protease inhibitors, thrombolytic anticoagulant, central nervous system stimulant, decongestant, diuretic vasodilator, antipsychotic, neurotransmifter, sedative, anaesthetic, surfactant, analgesic, anticancer agent, anti-inflammatory, antioxidant, antihistamine, vitamin, mineral, sterol, phytosterol, lipid and esters of fatty acids.

The active substance may also be selected from proteins, polypeptides, peptides, peptide analogs or peptide mimetics. Most preferably, the pH-sensitive, biologically active substance is selected from the proteins insulin, erythropoetin, calcitonin, LHRH, somatostain, epidermal growth factors, DNase, platelet derived growth factors, interleukins, interferons, cytokines, peptides of immunoglobulins, TNF and other biologically active peptides, monoclonal antibodies based on TNF inhibitors as well as antibodies based on inhibitors of cytokines and interleukins.

In a second aspect, the present invention provides a pharmaceutical composition comprising particles of the active substance produced by the method of the present invention.

The pharmaceutical composition is preferably in a form suitable for inhalation delivery, for example, for delivery by a metered dose inhaler or a nebuliser. Further, a transdermal delivery system may be used (eg, recent devices involving laser-generated or high-pressure dermal channels) and more traditional parenteral administration.

In a third aspect, the present invention provides a method of treatment of a subject, the method comprising administering to the subject, an effective amount of particles of a biologically active substance produced by the method or apparatus of the present invention.

Further, the use of such an apparatus allows higher yield and recovery of particles per run, the ability to process more material per run with longer run times, all of which lead to a more efficient process and greater production capacity.

Such an apparatus can be readily scaled up to process larger amounts of material.

The performance of the apparatus may be further enhanced by vibration and/or sonication/ultrasonication of the precipitation chamber. Again, without being limited to a mode of action, it is believed that this increases turbulence which increases efficacy. Other means of increasing turbulence may therefore be provided.

It will be understood that the term “comprises” (or its grammatical variants) as used in this specification is equivalent to the term “includes” and should not be taken as excluding the presence of other elements or features.

The method of the present invention, in its preferred forms, may provide one or more of the following advantages:
1. increased and quicker solubility of a desired solute in a solvent, especially for use downstream in another process;
2. drug particle formation in the absence of organic solvents which can be expensive to handle and fully extract;
3. increased efficiency of dense gas and supercritical fluid processes through greater and quicker generation of solutions, particularly solutions closer to saturation.

### BRIEF DESCRIPTION OF DRAWINGS AND PREFERRED EMBODIMENT

In order that the invention may be more readily understood, we provide the following non-limiting embodiments as examples.

FIG. 1 is a schematic diagram of a prior art process;

FIG. 2 is a schematic diagram of an embodiment of an apparatus that may be used in the process of the present invention;

FIG. 3 is a schematic diagram of an enlarged part of the apparatus shown in FIG. 2;

FIGS. 4(a) to (c) are schematic diagrams of alternative dense gas and solution transfer paths in accordance with the invention; and

FIGS. 5(a) to (e) is a series of diagrams illustrating the progressive contact of solute and dense gas in the apparatus of the present invention.

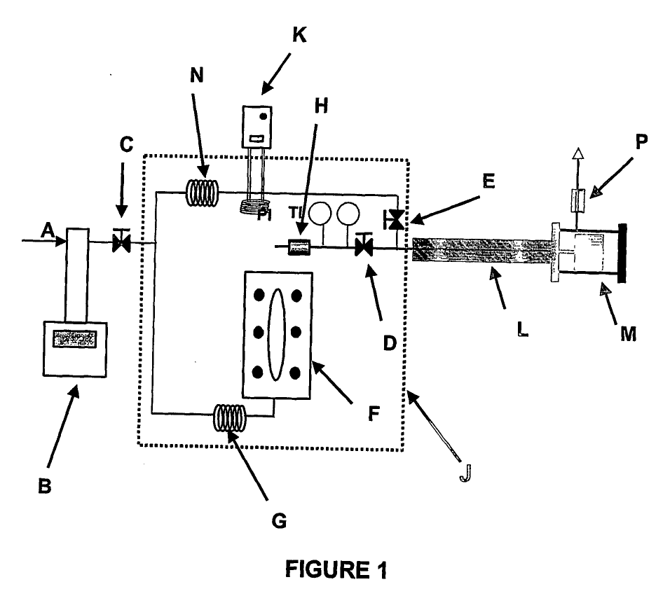

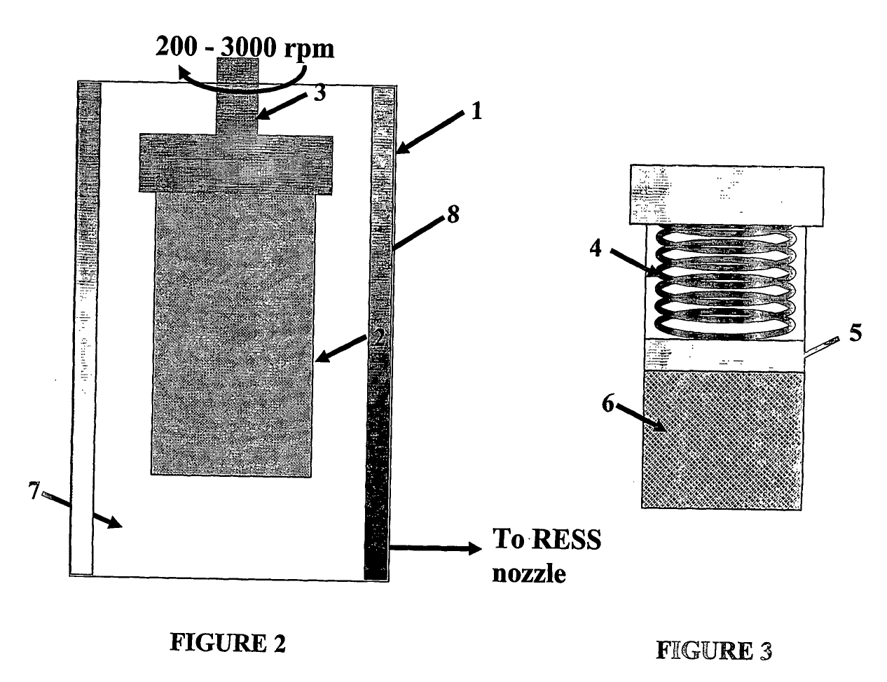

In this embodiment of the invention shown in FIG. 2, there is provided an autoclave or outer chamber 1 in which a porous inner chamber 2, the walls of which are preferably made from sintered metal such as stainless steel, is located. A means to create turbulence is provided. In the embodiment of FIG. 2, the turbulence is provided by the chamber being mounted on a rotatable mount 3 which can be rotated at speeds of 200 to 3000 rpm. In an alternative embodiment the turbulence may be a stirring mechanism, preferably magnetic, with a drive assembly located outside autoclave 1, and the stirrer itself located within porous chamber 2.

There is also provided (but not shown) an inlet for solvent into autoclave 1. Solvent such as CO₂ may be introduced through this inlet to space 7. The solute is pre-loaded into porous chamber 2 within autoclave 1 before the commencement of the dissolution process.

In FIG. 3, an internal side view of chamber 2 is shown. This shows the porous metal wall 4 of the chamber 2 with pore sizes of, for example, 1 to 5 microns. A resilient biasing means, namely spring 6, is located above a Teflon® plug 5 so as to maintain the as yet undissolved solute in a compact formation.

In use, solute is loaded into chamber 2. The chamber is then agitated to increase turbulence, primarily by rotation, either of the whole chamber itself, or a stirrer assembly within the chamber driven magnetically by an external drive assembly. This creates turbulence within chamber 2. Turbulence may also be created, or may be increased, by sonication or agitation of the entire apparatus.

Additionally, the inner surface of the outer chamber 1 may be provided with baffles 8 which increase turbulence and reduce circulating currents of solvent forming close to the inner surface of the outer chamber and thereby improve mass transfer of the solvent to the walls of the inner chamber. These baffles 8 shown as 5 mm perpendicular plates preferably extend from the wall of the outer chamber across the gap and may even extend to close proximity to the inner chamber. There may be any number of baffles with a pair of baffles shown in FIG. 2. These baffles are preferably spaced evenly around the inner wall of the outer chamber 1.

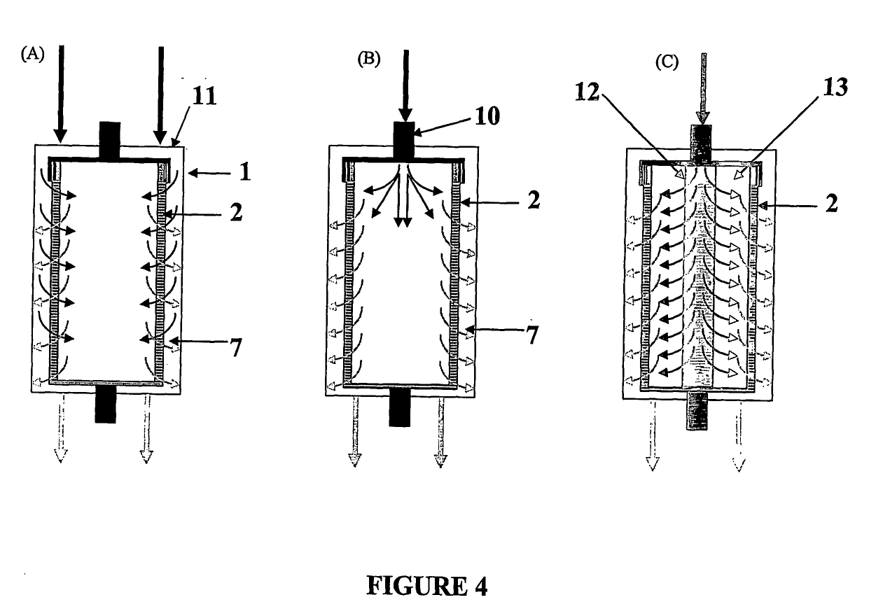

In the embodiment shown in FIG. 4(a), solvent is added to the autoclave 1 through an inlet (not shown) in the side or top wall 11 such that it reaches near critical or supercritical temperature and pressure in the chamber. The dense gas solvent permeates through the walls of the porous chamber 2 where it contacts and dissolves some solute contained within the porous chamber and then the resulting solution diffuses out into the autoclave space 7 surrounding the chamber. Hence, a bi-directional flow of both solute and dense gas is established. The solution is then passed through an outlet for precipitation.

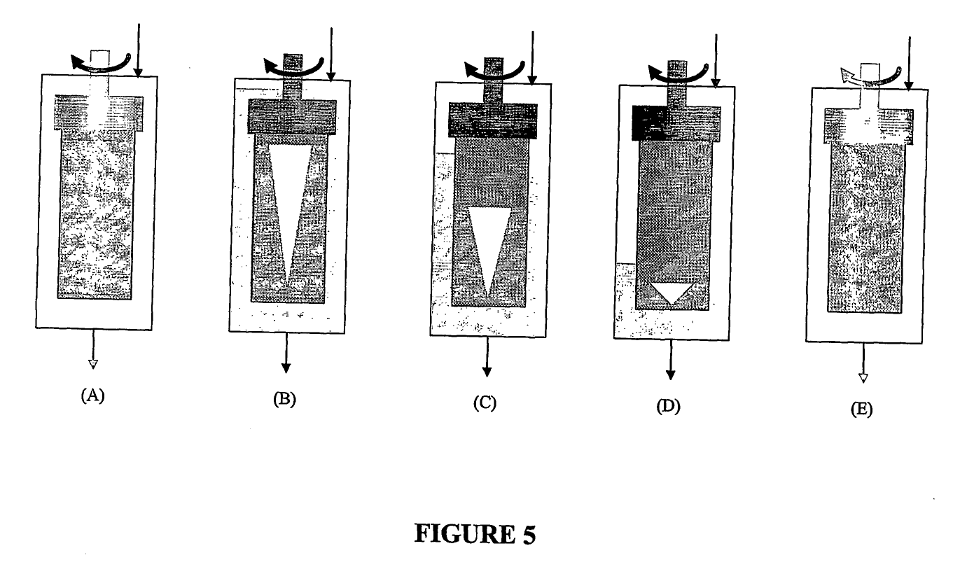

In FIG. 5, the flow of dense gas into the porous chamber and out of the outer chamber is shown. In FIG. 5(a), the porous chamber is full and progressively empties (FIGS. 5(b) to (d) until it is empty (FIG. 5(e)).

In the embodiment shown in FIG. 4(b), the dense gas is introduced through an axial shaft 10 directly into the porous chamber 2. With the rotation of the porous chamber 2, there is a forced convection flow of dense gas, into the chamber 2 and through the porous walls of the chamber 2. As the dense gas is delivered to the porous chamber under critical or near critical conditions, it contacts and forms a solution with the solute contained within chamber 2. The convective flow of the dense gas/solute solution through the chamber walls to outer chamber space 7 is then passed to the outlet of the outer chamber.

In an embodiment of the invention shown in FIG. 4(c), the porous chamber 2 is provided with a longitudinally extending shaft 12 which defines an annular region 13 in the porous chamber 2. The solute is positioned within the annular region 13 and dense gas fed into the longitudinally extending shaft 12. The shaft 12 is porous or perforated to allow contact of the dense gas and solute over the length of shaft in contact with solute. This arrangement further increases the available contact surface area for the dense gas to diffuse into the solute bed. This arrangement has the benefit of providing forced convective flow of dense gas through the porous wall and increased passage of gas through the packed solute in the annular region.

In each of the embodiments of FIG. 4(a) to 4(c), the solute/dense gas solution may then be passed to an expansion chamber for depressurizing through an exit nozzle to facilitate precipitation of the solute out of solution into fine particles which may then be recovered. Alternatively, the solution may be kept at temperature and/or pressure well above atmospheric for further processing downstream of this dissolution apparatus.

While suitable for any of the proteins mentioned above, the examples illustrating the invention are described using ibuprofen and simvastatin as the desired active ingredient. Similarly, for the purposes of illustration, the examples describe the use of CO₂ as the anti-solvent. These compounds represent a highly CO₂ soluble and poorly CO₂ soluble compound respectively.

### Example 1

A quantity of ibuprofen was added to the inner porous chamber of the apparatus shown in FIG. 2 and the plug put in place. CO₂ was then introduced continuously into the outer chamber. Table 1 shows the process conditions for the Example and results of the Example.

TABLE 1
Ibuprofen Processing Results

| Compound | Ibuprofen |
|---|---|
| MW, gmol | 206.3 |
| Equilibrium solubility in CO₂, mole fraction | 3.20E−03 |
| Temperature, ° C. | 38.5 |
| Pressure, bar | 150 |
| Stirring Speed, rpm | 800 |
| CO₂ Flowrate, ml/min | 50 ± 20 |
| Total Volume of CO₂, L | 6 |
| Mass of Product initially, g | 7.5 |
| Mass of product collected, g | 4.35 |
| Recovery, % | 58 |
| Processing Efficiency, g product/L CO₂ | 1.25 |
| Dynamic Solubility, HiG RESS | 3.14E−04 |
| Nozzle Diameter, mm | 2 |

The dynamic solubility is considerably lower than the equilibrium solution. This is because the equilibrium solubility is obtained at ideal conditions. The dynamic solubility for the small scale (or conventional) processing are unavailable. The volume of CO₂ passed through the trials was more than required to process the ibuprofen, hence the efficiency is lower. Overall recovery is low since a lot of product was lost through the 0.5 micron filter. This indicates that a considerable amount of product had a particle size of <0.5 μm.

### EXAMPLE 2

A similar Example was run for simvastatin. Simvastatin is a solid pharmaceutical at normal temperature and pressure, which is used therapeutically as an HMG-COA reductase inhibitor. It is readily available commercially. Liquid carbon dioxide (Industrial Grade 99.95%) is available from BOC Gases.

The simvastatin is heated in the chamber and held with minimal gap between the top of the powder and the Teflon® plug by the spring. CO₂ is added to the autoclave surrounding the chamber as a dense gas and the chamber spun at 800 rpm.

Fresh dense gas is added and gas from the autoclave is extracted by its own pressure through an escape nozzle. This dense gas has dissolved simvastatin in it for further processing.

### EXAMPLE 2

TABLE 2

| Compound | Simvastatin |
|---|---|
| MW, gmol | 418.2 |
| Equilibrium solubility in CO₂, dynamic small | 6.60E−06 |
| scale, mole fraction | |
| Temperature, ° C. | 46.2 |
| Pressure, bar | 160 |
| Stirring Speed, rpm | 800 |
| CO₂ Flowrate, ml/min | 40 ± 5 |
| Total Volume of CO₂, L | 25.87 |
| Mass of Product initially, g | 5.51 |
| Mass of product collected, g | 4.86 |
| Recovery, % | 88 |
| Processing Efficiency, g product/L CO₂ | 0.21 |
| HiG RESS Processing solubility, mole fraction | 2.64E−05 |
| Efficiency Improvement over conventional, % | 299 |
| Nozzle Diameter, mm | 2 |

The efficiency gain is compared to a dynamic rig using a packed bed versus the HiG RESS rotating cylinder technique and is thus more representative of the potential efficiency gain for dynamic processing.

1. An apparatus for dissolving or suspending a substance in a solvent comprising:
an outer chamber for containing a dense gas;
an inlet for supplying dense gas as a solvent;
a porous chamber within the outer chamber for containing a substance for dissolution or suspension with the solvent, the porous chamber having a wall which allows passage of solvent and the substance dissolved or suspended in the solvent, and
an outlet for removing solvent and solution and/or dispersion from the outer chamber and a turbulence means for creating turbulence within the porous chamber.

2. The apparatus of claim 1, wherein the inlet in the outer chamber supplies solvent directly to a mouth communicating with the porous chamber.

3. The apparatus of claim 1, wherein the inlet is in the wall of the outer chamber providing dense gas to the region between the porous chamber and the outer chamber.

4. The apparatus of claim 1, wherein the inlet supplies solvent to the porous chamber and the region between the porous chamber and the outer chamber.

5. The apparatus of claim 2, wherein the porous chamber is further provided with a longitudinally extending shaft communicating with the solvent inlet of the porous chamber.

6. The apparatus of claim 5, wherein the shaft is porous or perforated.

7. The apparatus of claim 5, wherein the substance is in the porous chamber in the region around the longitudinally extending shaft and the solvent enters the porous chamber through the shaft.

8. The apparatus of claim 1, wherein the turbulence creating means includes a drive means to drive a magnetic stirrer within the porous chamber.

9. The apparatus of claim 1, wherein the turbulence creating means includes a drive means to rotate the porous chamber within the outer chamber.

10. The apparatus of claim 1, wherein the turbulence creating means further comprises baffles within the outer chamber in the region between the porous chamber and the wall of the outer chamber.

11. The apparatus of claim 1, wherein the porous chamber is provided with a plug to hold the substance against the base of the inner chamber.

12. The apparatus of claim 11, wherein the plug is a planar element abutting the sides of the inner chamber and is held against the substance by a resilient biasing means.

13. A method of dissolving or suspending a substance in a dense gas comprising the steps of:
adding the substance to a porous chamber located within an outer chamber;
supplying the outer chamber with a dense gas as a solvent;
contacting the substance with the solvent within the porous chamber to form a solution or suspension within the porous chamber;
passing the solution or suspension through the walls of the porous chamber and removing the solution or suspension from the outer chamber.

14. The method of claim 13, wherein the dense gas is supplied to a region within the outer chamber and around the porous chamber.

15. The method of claim 13, wherein the turbulence is created within the porous chamber to dissolve the substance in the solvent and pass the solution through the pores of the porous chamber into the region around the porous chamber.

16. The method of claim 13, wherein the dense gas is supplied directly to an inlet in the porous chamber to contact the substance within the porous chamber.

17. The method of claim 13, further comprising the step of rotating the porous chamber to dissolve the substance in the solvent and passing the solution through the porous walls to the outlet of the outer chamber.

18. The method of claim 16, wherein the porous chamber is further provided with a longitudinally extending shaft communicating with the inlet of the porous chamber.

19. The method of claim 18, wherein the shaft is porous or perforated.

20. The method of claim 18, wherein the substance is in the annular region around the longitudinally extending shaft and the solvent enters the porous chamber through the shaft.

21. A method for producing fine particles using the apparatus according to claim 1.

22. A method of producing fine particles comprising the steps of dissolving or suspending a substance in a dense gas according to the method of claim 13, further including the step of depressurizing the substance solvent solution to precipitate fine particles of the substance.

23. The method of claim 22, wherein the substance is a biologically active substance used for diagnostic or therapeutic purposes.

24. A pharmaceutical composition comprising fine particles of an active substance produced by the method of claim 13.

25. A method of treatment of the subject comprising the steps of administering to the subject an affective amount of particles of a biologically active substance produced by the method of claim 13.

26. A method of treatment of the subject comprising the steps of administering to the subject an affective amount of particles of a biologically active substance produced using the apparatus of claim 1.
